(19) United States
(12) Patent Application Publication
(10) Pub. No.: US 2019/0334199 A1
(43) Pub. Date: Oct. 31, 2019

(54) SOLID ELECTROLYTE, BATTERY, AND MANUFACTURING METHOD FOR BATTERY

(71) Applicant: FUJITSU LIMITED, Kawasaki-shi (JP)

(72) Inventors: Kenji Homma, Atsugi (JP); Jiyunichi Iwata, Sagamihara (JP); Chioko Kaneta, Kawasaki (JP); Shintaro SATO, Atsugi (JP); Toyoo Miyajima, Isehara (JP)

(73) Assignee: FUJITSU LIMITED, Kawasaki-shi (JP)

(21) Appl. No.: 16/273,692

(22) Filed: Feb. 12, 2019

(30) Foreign Application Priority Data
Apr. 27, 2018 (JP) 2018-086867

(51) Int. Cl. H01M 10/0562; H01M 10/052

(52) U.S. Cl. CPC H01M 10/0562; H01M 2300/0071; H01M 10/052

(57) ABSTRACT

A solid electrolyte which is an oxide-based solid electrolyte, the solid electrolyte includes lithium (Li), phosphorus (P), boron (B), sulfur (S), and oxygen (O) as constituent elements.

### CROSS-REFERENCE TO RELATED APPLICATION

This application is based upon and claims the benefit of priority of the prior Japanese Patent Application No. 2018-086867, filed on Apr. 27, 2018, the entire contents of which are incorporated herein by reference.

### FIELD

The embodiments discussed herein are related to a solid electrolyte, a battery, and a manufacturing method for a battery.

### BACKGROUND

Environmental power generation technology that accumulates electricity generated from minute energy such as, for example, solar energy, vibration energy, and human and animal body temperature to be used, for example, for sensors and wireless transmission power requires a secondary battery that is safe and highly reliable under any global environments.

Currently, in a liquid-based battery using an organic solvent solution being widely used, there is a concern that a positive electrode active material is deteriorated when the cycle is repeated, which may result in decrease in battery capacity. Further, in the liquid-based battery, there is also a concern that an organic electrolytic solution in the battery may catch fire and ignite due to the short-circuit of battery by the formation of dendrite.

Therefore, for an environmental power generation device considered to be used, for example, for 10 years or more, the liquid-based battery has low reliability and low safety.

Therefore, an all-solid lithium secondary battery in which all constituent materials are made solid is attracting attention (see, e.g., International Publication Pamphlet No. WO 2013/024537). The all-solid lithium secondary battery has no concern of leakage or ignition and also has excellent cycle characteristics.

Related techniques are disclosed in, for example, International Publication Pamphlet No. WO 2013/024537.

### SUMMARY

According to an aspect of the embodiments, a solid electrolyte which is an oxide-based solid electrolyte, the solid electrolyte includes lithium (Li), phosphorus (P), boron (B), sulfur (S), and oxygen (O) as constituent elements.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic view of an example of the disclosed all-solid state battery;

FIG. 2 is a phase diagram summarizing the ionic conductivities of Examples 1 to 3 and Comparative Examples 1 to 8;

FIG. 3 is a graph illustrating results of X-ray diffraction of Comparative Example 6 (number v), Example 3 (number vi), Example 2 (number vii), and Comparative Example 8 (number viii);

FIG. 4A is a phase diagram obtained from results of TG-DTA measurement (Part 1);

FIG. 4B is a phase diagram obtained from results of TG-DTA measurement (Part 2); and

FIG. 4C is a phase diagram obtained from results of TG-DTA measurement (Part 3).

### DESCRIPTION OF EMBODIMENTS

A sulfide-based solid electrolyte which is also used in the technique disclosed in the pamphlet of International Publication No. 2013/024537 has a problem in that the sulfide-based solid electrolyte is unstable under the atmosphere. In the meantime, an oxide-based solid electrolyte is stable under the atmosphere.

In recent years, a sulfide-based solid electrolyte has been proposed as a solid electrolyte comparable to a liquid-based electrolyte. However, the sulfide-based solid electrolyte generates hydrogen sulfide when it is exposed to the atmosphere. Therefore, in the production site of sulfide-based solid electrolyte, safety management of manufacturing equipment and maintenance of working environment for personnel are necessary.

For example, as one example of manufacturing an all-solid lithium secondary battery, there is a method in which a positive electrode, an electrolyte, and a negative electrode are each molded into a sheet shape and are then laminated and integrally sintered. When a sulfide-based solid electrolyte is used as an electrolyte, in order to maintain the performance of the material and to suppress generation of hydrogen sulfide, there is a need to carry out each step of handling the positive electrode, the electrolyte, and the negative electrode in a dry atmosphere containing no moisture.

Specialized and expensive equipment such as a glove box and a dry room are necessary for formation and maintenance of the dry atmosphere, which may result in increase of the costs of battery manufacture.

Further, when the sulfide-based solid electrolyte is used for a battery, there is a concern that hydrogen sulfide may be generated when the battery is broken or even when the battery is discarded after use, for which safety measures are required.

In the meantime, the oxide-based solid electrolyte is more stable to the atmosphere than the sulfide-based solid electrolyte. In addition, even when the oxide-based solid electrolyte is hydrolyzed by being mixed with moisture, it does not discharge a toxic gas. Therefore, when the oxide-based solid electrolyte is used, it is possible to eliminate the concern of generation of hydrogen sulfide peculiar to the sulfide-based solid electrolyte in the related art, thereby ensuring safety and suppressing the manufacturing cost.

The internal resistance of the all-solid lithium secondary battery is largely due to the ionic conductivity of a solid electrolyte, that is, a lithium ion conductor. Therefore, in order to reduce the internal resistance of the all-solid lithium secondary battery and improve the output characteristics thereof, it is necessary to improve the ionic conductivity of the solid electrolyte, that is, the lithium ion conductor.

As for the oxide-based solid electrolyte, for example, a Li₂SO₄—Li₃PO₄ two-component system is known.

This two-component system has the ionic conductivity higher than the end component composition (Li₂SO₄, Li₃PO₄). As disclosed in a Non-Patent Document by Touboul, M., N. Sephar, et al. entitled “Electrical conductivity and phase diagram of the system Li₂SO₄—Li₃PO₄”, Solid State Ionics 38(3): 225-229, the physical properties of a solid solution system are measured and the composition of Li₂SO₄—Li₃PO₄ (=20:70) has the highest ionic conductivity at the temperature of 300° C. to 500° C.

However, it is not known that a three-component oxide-based solid electrolyte exhibits high ionic conductivity.

Therefore, the present inventors have conducted intensive studies and found that a three-component oxide-based solid electrolyte of Li₂SO₄—Li₃PO₄—Li₃BO₃ exhibits high ionic conductivity, thereby completing the present disclosure.

(Solid Electrolyte)

The disclosed solid electrolyte is an oxide-based solid electrolyte.

The solid electrolyte contains lithium (Li), phosphorus (P), boron (B), sulfur (S), and oxygen (O) as constituent elements.

In the disclosed technique, the oxide-based solid electrolyte refers to a solid electrolyte that has a skeleton including an oxoacid ion in which oxygen atoms are coordinated with a central element, as a counter anion of a lithium ion.

The solid electrolyte has a skeleton that includes, for example, lithium oxoacid of phosphorus, lithium oxoacid of boron, and lithium oxoacid of sulfur.

An oxoacid group of phosphorus that forms the skeleton of the solid electrolyte may be, for example, a PO₄ group.

An oxoacid group of boron that forms the skeleton of the solid electrolyte may be, for example, a BO₃ group or a BO₄ group. It is considered that the BO₄ group is formed by replacing phosphorus (P) of the PO₄ group with boron (B).

An oxoacid group of sulfur that forms the skeleton of the solid electrolyte may be, for example, an SO₄ group.

In a preferred aspect of the solid electrolyte, the oxoacid group of phosphorus, the oxoacid group of boron, and the oxoacid group of sulfur form a skeleton of the crystal structure of the solid electrolyte, and lithium (Li) ions as carriers are arranged in the interstices of the skeleton of the crystal structure.

In the solid electrolyte, the phosphorus (P) and the sulfur (S) preferably satisfy the following formula (1), more preferably satisfy the following general formula (1-1), and particularly preferably satisfy the following general formula (1-2) in terms of element ratio in that the ionic conductivity is superior.

In the solid electrolyte, the boron (B) and the sulfur (S) preferably satisfy the following formula (2), more preferably satisfy the following general formula (2-1), and particularly preferably satisfy the following general formula (2-2) in terms of element ratio in that the ionic conductivity is more superior.

In the solid electrolyte, the phosphorus (P) and the boron (B) preferably satisfy the following formula (3), and more preferably satisfy the following general formula (3-1) in terms of element ratio in that the ionic conductivity is more superior.

0.10≤[P/(P+S)]≤0.90 (1)

0.10≤[S/(S+B)]≤0.90 (2)

0.10≤[B/(B+P)]≤0.90 (3)

0.25≤[P/(P+S)]≤0.75 (1-1)

0.25≤[S/(S+B)]≤0.75 (2-1)

0.25≤[B/(B+P)]≤0.75 (3-1)

0.50≤[P/(P+S)]≤0.75 (1-2)

0.50≤[S/(S+B)]≤0.75 (2-2)

The solid electrolyte preferably satisfies the formulas (1), (2), and (3), more preferably satisfies the formulas (1-1), (2-1), and (3-1), and particularly preferably satisfies the formulas (1-1), (2-2), and (3-1).

In addition, in the solid electrolyte, the phosphorus (P), the sulfur (S), and the boron (B) preferably satisfy the following formulas (4), (5), and (6), and more preferably satisfy the following general formulas (4-1), (5-1), and (6-1) in terms of element ratio in that the ionic conductivity is more superior.

0.20≤[P/(P+S+B)]≤0.60 (4)

0.20≤[S/(P+S+B)]≤0.60 (5)

0.20≤[B/(P+S+B]≤0.60 (6)

0.20≤[P/(P+S+B)]≤0.30 (4-1)

0.40≤[S/(P+S+B)]≤0.60 (5-1)

0.20≤[B/(P+S+B]≤0.30 (6-1)

It is preferable that the solid electrolyte has peaks at 20=25.5° to 25.8° and 26.0° to 26.3° in X-ray diffraction using a CuKα ray.

An X-ray diffraction measurement of the solid electrolyte may be carried out using, for example, a powder X-ray diffraction measurement apparatus (using, e.g., Rigaku, miniflex 600, CuKα).

The solid electrolyte is not particularly limited in the shape but may be appropriately selected depending on the purpose, and may be of a powder shape or a pellet shape.

(Method of Manufacturing Solid Electrolyte)

The disclosed method for manufacturing the solid electrolyte includes a process of heating a mixture containing lithium (Li), phosphorus (P), boron (B), sulfur (S), and oxygen (O) as constituent elements to obtain the solid electrolyte.

The solid electrolyte is the disclosed solid electrolyte.

<Process of Obtaining Solid Electrolyte>

The mixture contains lithium (Li), phosphorus (P), boron (B), sulfur (S), and oxygen (O) as constituent elements.

A method of obtaining the mixture may be, for example, one of the following first to third methods.

Heating may be performed as appropriate to obtain the mixture.

Raw materials are mixed at a predetermined ratio to obtain the mixture.

<<First Method>>

The first method is to mix lithium oxoacid of phosphorus, lithium oxoacid of boron, and lithium oxoacid of sulfur to obtain the mixture.

The lithium oxoacid of phosphorus may be, for example, Li₃PO₄.

The lithium oxoacid of boron may be, for example, Li₃BO₃.

The lithium oxoacid of sulfur may be, for example, Li₂SO₄.

<<Second Method>>

The second method is to mix a lithium source, oxoacid of phosphorus, oxoacid of boron, and oxoacid of sulfur to obtain the mixture.

The lithium source may be, for example, lithium hydroxide (LiOH).

The oxoacid of phosphorus may be, for example, H₃PO₄.

The oxoacid of boron may be, for example, H₃BO₃.

The oxoacid of sulfur may be, for example, H₂SO₄.

A specific example of the second method is as follows.

A predetermined amount of each raw material is dissolved in warm water (e.g., pure water at 50° C.) to obtain a solution.

The obtained solution is dried at about 150° C. to obtain a precursor.

The obtained precursor is the mixture.

<<Third Method>>

The third method is to mix a lithium source, ammonium oxoacid of phosphorus, oxide of boron, and lithium oxoacid of sulfur to obtain the mixture.

The lithium source may be, for example, Li₂CO₃.

The ammonium oxoacid of phosphorus may be, for example, (NH₄)₂HPO₄.

The oxide of boron may be, for example, B₂O₃.

The lithium oxoacid of sulfur may be, for example, Li₂SO₄.

A specific example of the third method is as follows.

A predetermined amount of each raw material is placed in an agate mortar and mixed for a predetermined time (e.g., 15 minutes) with a pestle to obtain a precursor.

The obtained precursor is pre-sintered (e.g., heated at 340° C. for 6 hours) and then cooled to obtain a pre-sintered body.

The obtained pre-sintered body is the mixture.

The heating temperature at the time of heating the mixture is not particularly limited as long as it is a temperature at which an oxide-based solid electrolyte may be obtained, and may be appropriately selected according to the purpose. However, the heating temperature is preferably 500° C. or higher, more preferably 550° C. or higher from the viewpoint of good solid solution. The upper limit of the heating temperature is not particularly limited but may be appropriately selected according to the purpose, but it is preferably 1,000° C. or lower.

The heating time for heating the mixture is not particularly limited but may be appropriately selected according to the purpose. For example, the heating time may be, for example, 1 hour to 48 hours or 5 hours to 24 hours.

(Battery)

The disclosed battery includes at least a positive electrode active material layer, a solid electrolyte layer, and a negative electrode active material layer, and further includes other members as necessary.

The disclosed battery is also referred to as an all-solid state battery and may be, for example, an all-solid lithium ion secondary battery.

The all-solid state battery does not contain a liquid component in at least the positive electrode active material layer, the solid electrolyte layer, and the negative electrode active material layer.

<Positive Electrode Active Material Layer>

The positive electrode active material layer is not particularly limited as long as it contains a positive electrode active material, and may be appropriately selected according to the purpose.

The positive electrode active material layer may be the positive electrode active material itself or a mixture of the positive electrode active material and the solid electrolyte.

The solid electrolyte is preferably the disclosed solid electrolyte.

The positive electrode active material is not particularly limited but may be appropriately selected according to the purpose. For example, the positive electrode active material may be a lithium-containing composite oxide. The lithium-containing composite oxide is not particularly limited as long as it is a composite oxide containing lithium and another metal, and may be appropriately selected according to the purpose. For example, the lithium-containing composite oxide may be LiCoO₂, LiNiO₂, LiCrO₂, LiVO₂, LiMₓMn₂₋ₓO₄ (M is at least one of Co, Ni, Fe, Cr, and Cu, 0≤x<2), LiFePO₄, or LiCoPO₄.

These may be used either alone or in combination of two or more.

The average thickness of the positive electrode active material layer is not particularly limited but may be appropriately selected according to the purpose. For example, the average thickness is preferably 1 μm to 100 μm, more preferably 1 μm to 10 μm.

The method of forming the positive electrode active material layer is not particularly limited but may be appropriately selected according to the purpose. For example, the method may be a sputtering method using the target material of the positive electrode active material or a method of compressing and molding the positive electrode active material.

<Negative Electrode Active Material Layer>

The negative electrode active material layer is not particularly limited as long as it contains a negative electrode active material, and may be appropriately selected according to the purpose.

The negative electrode active material layer may be the negative electrode active material itself or a mixture of the negative electrode active material and the solid electrolyte.

The solid electrolyte is preferably the disclosed solid electrolyte.

The negative electrode active material is not particularly limited but may be appropriately selected according to the purpose. For example, the negative electrode active material may be lithium, lithium aluminum alloy, Li₄Ti₅O₁₂, amorphous carbon, natural graphite or artificial graphite.

The average thickness of the negative electrode active material layer is not particularly limited but may be appropriately selected according to the purpose. For example, the average thickness is preferably 1 μm to 100 μm, more preferably 1 μm to 10 μm.

The method of forming the negative electrode active material layer is not particularly limited but may be appropriately selected according to the purpose. For example, the method may be a sputtering method using the target material of the negative electrode active material, a method of compressing and molding the negative electrode active material, or a method of depositing the negative electrode active material.

<Solid Electrolyte Layer>

The solid electrolyte layer is the disclosed solid electrolyte.

The average thickness of the solid electrolyte layer is not particularly limited but may be appropriately selected according to the purpose. For example, the average thickness is preferably 50 μm to 500 μm, and more preferably 50 μm to 100 μm.

<Other Members>

Other members are not particularly limited but may be appropriately selected according to the purpose. For example, other members may be a positive electrode current collector, a negative electrode current collector, and a battery case.

<<Positive Electrode Current Collector>>

The size and structure of the positive electrode current collector are not particularly limited but may be appropriately selected according to the purpose.

The material of the positive electrode current collector may be, for example, die steel, stainless steel, aluminum, aluminum alloy, titanium alloy, copper, gold, or nickel.

The shape of the positive electrode current collector may be, for example, a foil shape, a plate shape, or a mesh shape.

The average thickness of the positive electrode current collector may be, for example, 10 μm to 500 μm.

<<Negative Electrode Current Collector>>

The size and structure of the negative electrode current collector are not particularly limited but may be appropriately selected according to the purpose.

The material of the negative electrode current collector may be, for example, die steel, gold, indium, nickel, copper, or stainless steel.

The shape of the negative electrode current collector may be, for example, a foil shape, a plate shape, or a mesh shape.

The average thickness of the negative electrode current collector may be, for example, 10 μm to 500 μm.

<<Battery Case>>

The battery case is not particularly limited but may be appropriately selected according to the purpose. For example, the battery case may be a known laminated film that is usable in an all-solid battery in the related art. The laminated film may be, for example, a laminated film made of resin, a film obtained by depositing metal on a resin laminated film.

The shape of the battery is not particularly limited but may be appropriately selected according to the purpose. For example, the shape may be a cylindrical shape, a square shape, a button shape, a coin shape, or a flat shape.

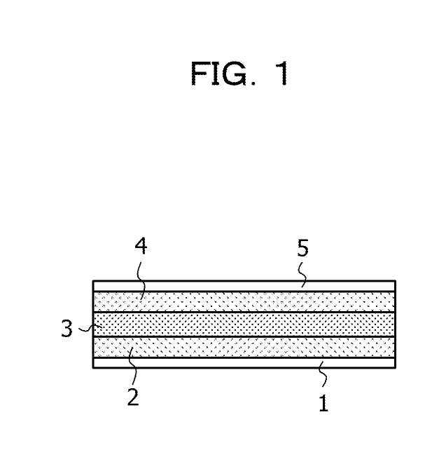

FIG. 1 is a schematic sectional view of an example of the disclosed battery (all-solid battery). As illustrated in FIG. 1, the battery includes a positive electrode current collector 1, a positive electrode active material layer 2, a solid electrolyte layer 3, a negative electrode active material layer 4, and a negative electrode current collector 5, which are laminated in this order.

(Method of Manufacturing Battery)

<One Aspect>

One aspect of the disclosed method for manufacturing a battery includes a step of forming a negative electrode active material layer and a step of forming a positive electrode active material layer, and further includes other steps as necessary.

The disclosed battery manufacturing method is one aspect of the method for manufacturing the disclosed battery.

<<Step of Forming Negative Electrode Active Material Layer>>

The step of forming the negative electrode active material layer is not particularly limited as long as it is a step of forming a negative electrode active material layer on one side of the solid electrolyte layer, and may be appropriately selected according to the purpose. For example, this step may be a sputtering method using the target material of the negative electrode active material or a method of depositing the negative electrode active material.

The solid electrolyte layer is the disclosed solid electrolyte.

According to the step of forming the negative electrode active material layer, the negative electrode active material layer described in the description of the disclosed battery is formed on one surface of the solid electrolyte layer.

<<Step of Forming Positive Electrode Active Material Layer>>

The step of forming the positive electrode active material layer is not particularly limited as long as it is a step of forming a positive electrode active material layer on the opposite side of the solid electrolyte layer, and may be appropriately selected according to the purpose. For example, this step may be a sputtering method using the target material of the positive electrode active material.

According to the step of forming the positive electrode active material layer, the positive electrode active material layer described in the description of the disclosed battery is formed on the opposite surface of the solid electrolyte layer.

<Other Aspects>

As for another method of the disclosed battery manufacturing method, the battery may be obtained by integrally sintering the laminate of the positive electrode active material layer, the solid electrolyte layer, and the negative electrode active material layer.

The positive electrode active material layer is, for example, a mixture obtained by mixing a positive electrode active material, a solid electrolyte, and optionally a conductive auxiliary agent. It is preferable that the solid electrolyte contained in the mixture is the disclosed solid electrolyte.

The solid electrolyte layer is the disclosed solid electrolyte.

The negative electrode active material layer is, for example, a mixture obtained by mixing a negative electrode active material, a solid electrolyte, and optionally a conductive auxiliary agent. It is preferable that the solid electrolyte contained in the mixture is the disclosed solid electrolyte.

The positive electrode active material may be, for example, the positive electrode active material exemplified in the description of the disclosed battery.

The negative electrode active material may be, for example, the negative electrode active material exemplified in the description of the disclosed battery.

The conductive auxiliary agent may be, for example, fine particles of amorphous carbon such as acetylene black, carbon black, Ketjen black, graphite, and needle coke, or carbon powder such as carbon nanofibers.

The integral sintering is performed, for example, by heating the laminate obtained by compressing and laminating the positive electrode active material layer, the solid electrolyte layer, and the negative electrode active material layer.

The heating temperature for heating the laminate is not particularly limited but may be appropriately selected according to the purpose. For example, the heating temperature is preferably 500° C. or higher, and more preferably 550° C. or higher. The upper limit of the heating temperature is not particularly limited but may be appropriately selected according to the purpose. For example, the upper limit of the heating temperature is preferably 1,000° C. or lower.

The heating time for heating the laminate is not particularly limited but may be appropriately selected according to the purpose. For example, the heating time may be 1 hour to 48 hours, or 5 hours to 24 hours.

### EXAMPLES

Hereinafter, examples of the disclosed technique will be described, but the disclosed technique is not limited to these examples.

### Example 1

Li₃PO₄ powder, Li₃BO₃ powder, and Li₂SO₄ powder were compounded at a compounding amount in the molar ratio represented in Table 1 and were mixed using an agate mortar in a glove box. Thereafter, 0.5 g of the powders was weighted and pressed with a uniaxial pressing jig and was molded to a thickness of 3 mm to 5 mm and a diameter of 10 mmφ to obtain a pellet.

Next, the obtained pellet was heated to 600° C. while raising the temperature in an electric furnace completely replaced with dry argon, and then held at 600° C. for 12 hours. After the heating and holding, the pellet was naturally cooled to the room temperature to obtain a solid electrolyte (lithium ion conductor).

### Examples 2 and 3

In the same manner as in Example 1 except that the compounding amounts of the Li₃PO₄ powder, the Li₃BO₃ powder, and the Li₂SO₄ powder were changed to those represented in Table 1, solid electrolytes (lithium ion conductors) were obtained.

### Comparative Examples 1 to 8

In the same manner as in Example 1 except that the compounding amounts of the Li₃PO₄ powder, the Li₃BO₃ powder, and the Li₂SO₄ powder were changed to those represented in Table 1, solid electrolytes (lithium ion conductors) were obtained.

[Evaluation on Solid Electrolyte]

<Ionic Conductivity Measurement>

Au was deposited on both sides of the solid electrolyte pellet prepared as described above to form a blocking electrode. Then, a voltage of 1 mV-50 mV was applied in the range of 7 MHz to 100 Hz by an AC impedance method, and a current response was plotted. The measurement atmosphere was made under dry argon flow at 300° C. As an evaluation device, a frequency response analyzer incorporated in VMP-300 multichannel electrochemical measurement system available from BioLogics was used.

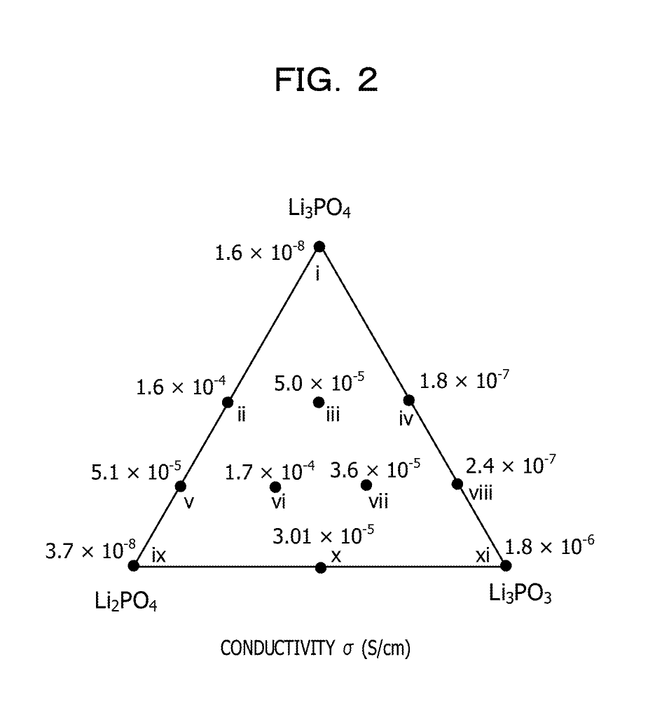

The measurement results are represented in Table 1 and are summarized in FIG. 2 as a phase diagram.

TABLE 1

| | | | | | Ionic |
|---|---|---|---|---|---|
| | | | | | conductivity |
| | | Compounding amount (molar ratio) | | | [S/cm] (at |
| | Number | Li₃PO₄ | Li₃BO₄ | Li₂SO₄ | 300° C.) |
| Example 1 | iii | 50 | 25 | 25 | 5.0 × 10⁻⁵ |
| Example 2 | vii | 25 | 50 | 25 | 3.6 × 10⁻⁵ |
| Example 3 | vi | 25 | 25 | 50 | 1.7 × 10⁻⁴ |
| Comp. Ex. 1 | i | 100 | 0 | 0 | 1.6 × 10⁻⁸ |
| Comp. Ex. 2 | xi | 0 | 100 | 0 | 1.8 × 10⁻⁶ |
| Comp. Ex. 3 | ix | 0 | 0 | 100 | 3.7 × 10⁻⁸ |
| Comp. Ex. 4 | ii | 50 | 0 | 50 | 1.6 × 10⁻⁴ |
| Comp. Ex. 5 | iv | 50 | 50 | 0 | 1.8 × 10⁻⁷ |
| Comp. Ex. 6 | v | 25 | 0 | 75 | 5.1 × 10⁻⁵ |
| Comp. Ex. 7 | x | 0 | 50 | 50 | 3.0 × 10⁻⁵ |
| Comp. Ex. 8 | viii | 25 | 75 | 0 | 2.4 × l0⁻⁷ |

<XRD Measurement>

In order to investigate the crystal structure of a solid solution, the solid electrolyte pellet was pulverized in an agate mortar and subjected to the powder X-ray diffraction measurement (using Rigaku, miniflex 600, and CuK-alpha).

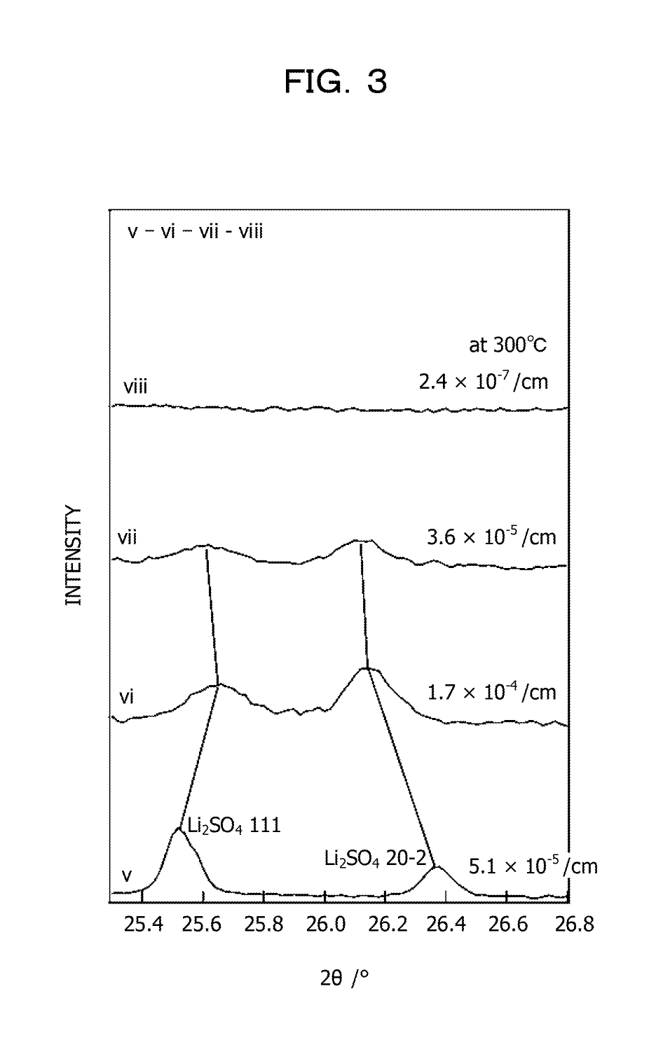

The results of X-ray diffraction of Comparative Example 6 (number v), Example 3 (number vi), Example 2 (number vii), and Comparative Example 8 (number viii) in which the molar amount of Li₃PO₄ is 25 mol % are summarized in FIG. 3.

It is considered that an ionic conduction path built by the following (A) and (B) is a factor of improvement of ionic conductivity.

(A) Lattice change of Li₂SO₄ as base crystal of v-vi-vii-viii line

(B) Shrinkage and expansion of lattice caused by solid solution of Li₃BO₃

<TG-DTA Measurement>

Thermogravimetry-differential thermal analysis (TG-DTA) measurement was carried out by the following method.

For the TG-DTA measurement, an apparatus named Rigaku TG8120 was used in which the temperature increase/decrease speed was 10° C./min, the atmosphere was dry Ar 100% (dew point is −60° C. or less), the sample amount was 5 mg to 10 mg, and the sample PAN was Pt.

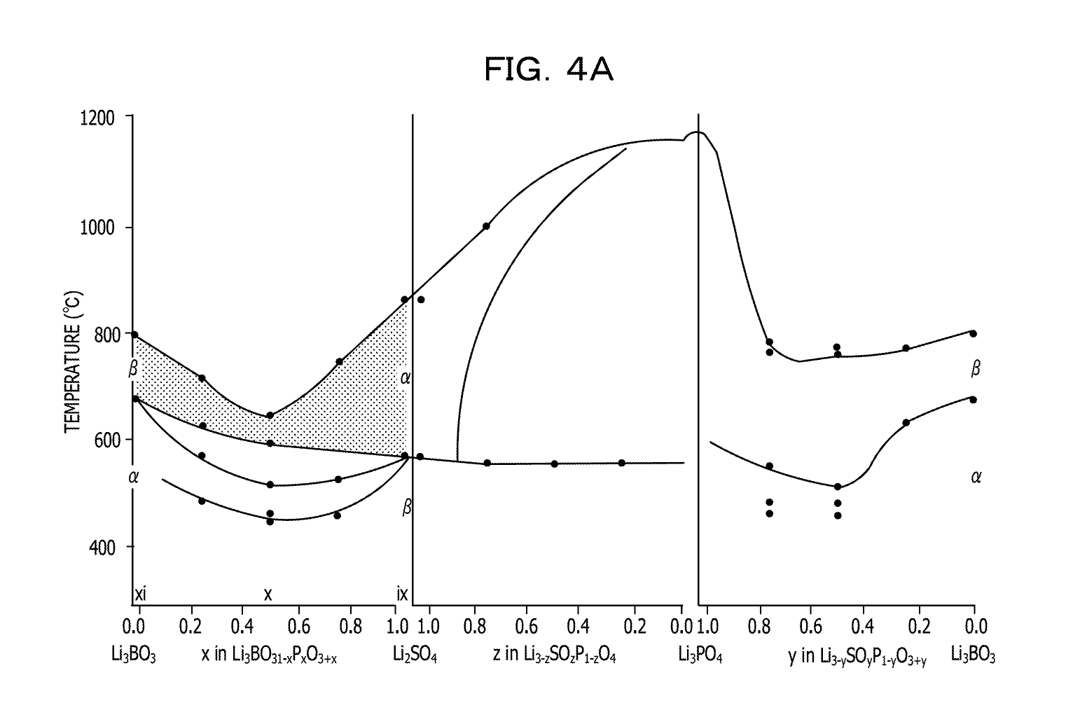

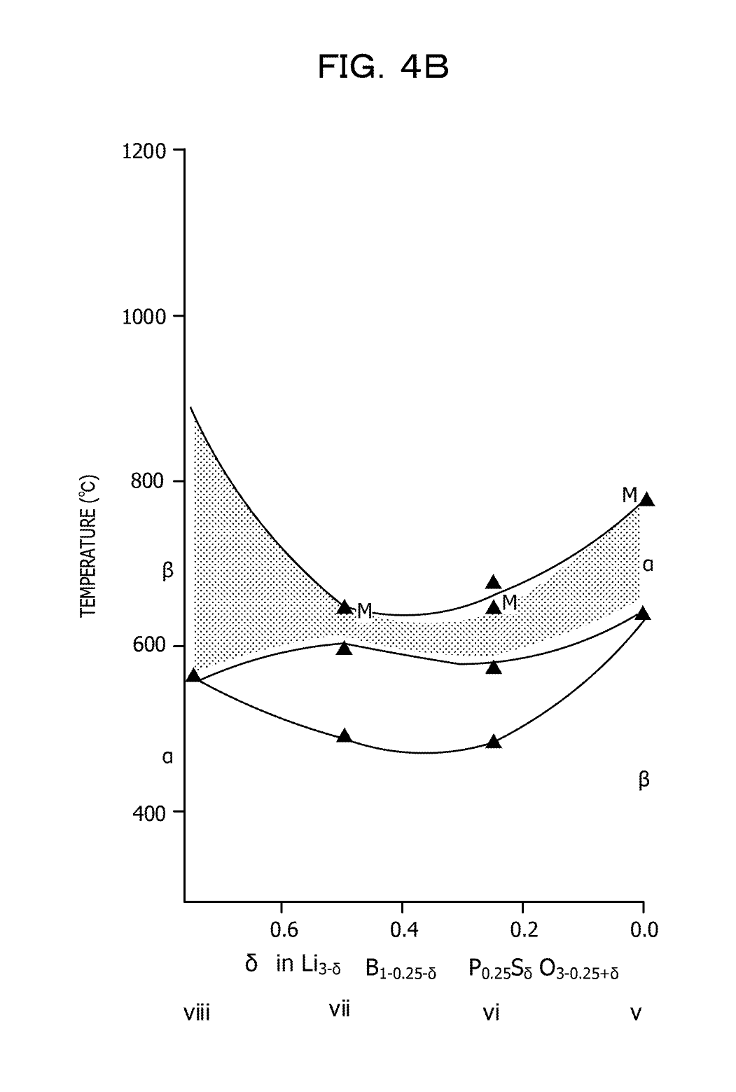

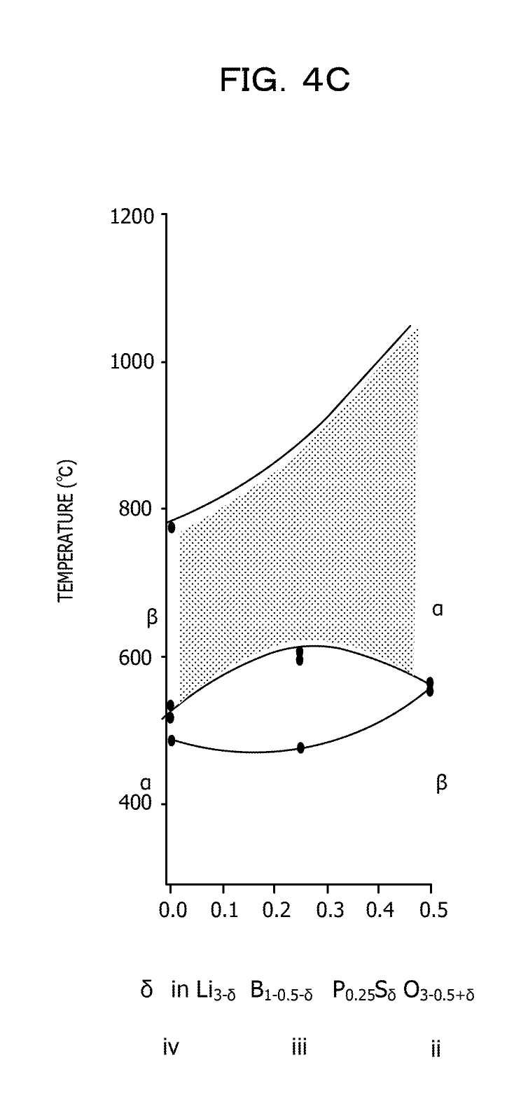

The results of the TG-DTA measurement on the solid electrolyte prepared in the same manner as in Example 1 for samples in which the compounding amount of Li₃PO₄, Li₃BO₃, and Li₂SO₄ was variously changed are illustrated in FIGS. 4A to 4C as phase diagrams.

From FIG. 4A to FIG. 4C, the mixing ratio of the crystal phases and the condition range of the sintering temperature to obtain high ionic conductivity were confirmed.

FIG. 4A is a phase diagram when the triangular phase diagram of FIG. 2 is deployed with the Li₃BO₃ point as a boundary. In the phase diagram of FIG. 4A, the horizontal axis represents the triangular phase and the vertical axis represents temperature. Each point is plotted based on the exothermic peak obtained from TG-DTA. The uppermost line is the melting point Tm and indicates a phase of melting at a temperature above the uppermost line.

The crystal phases similar to vi and vii that may obtain the high ionic conductivity illustrated in FIG. 3 are in the range indicated by the shadow (gray) in the range of the two-component Li₃BO₃—Li₂SO₄, that is, by the solid state reaction between high temperature phase β-Li₃BO₃ and high temperature phase α-Li₂SO₄. This range is similarly generated in a three-component system additionally including an Li₃PO₄ component as well and is obtained as vi and vii (see, e.g., FIG. 4B). Further, it was confirmed that a crystal phase similar to vi and vii was obtained in the crystal of iii in which the component of γ-Li₃PO₄ was increased. By making synthesis in the composition range painted with the shadow (gray) and the temperature range, a crystal phase exhibiting high ionic conductivity is obtained.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. A solid electrolyte which is an oxide-based solid electrolyte, the solid electrolyte comprising:
lithium (Li), phosphorus (P), boron (B), sulfur (S), and oxygen (O) as constituent elements.

2. The solid electrolyte according to claim 1,
wherein the solid electrolyte has a skeleton including lithium oxoacid of phosphorus, lithium oxoacid of boron, and lithium oxoacid of sulfur.

3. The solid electrolyte according to claim 1,
wherein the phosphorus (P) and the sulfur (S) satisfy the following formula (1) in terms of element ratio, the boron (B) and the sulfur (S) satisfy the following formula (2) in terms of element ratio, and the phosphorus (P) and the boron (B) satisfy the following formula (3) in terms of element ratio.
0.10≤[P/(P+S)]≤0.90 (1)
0.10≤[S/(S+B)]≤0.90 (2)
0.10≤[B/(B+P)]≤0.90 (3)

4. The solid electrolyte according to claim 1,
wherein the phosphorus (P) and the sulfur (S) satisfy the following formula (1-1) in terms of element ratio, the boron (B) and the sulfur (S) satisfy the following formula (2-1) in terms of element ratio, and the phosphorus (P) and the boron (B) satisfy the following formula (3-1) in terms of element ratio.
0.25≤[P/(P+S)]≤0.75 (1-1)
0.25≤[S/(S+B)]≤0.75 (2-1)
0.25≤[B/(B+P)]≤0.75 (3-1)

5. The solid electrolyte according to claim 1,
wherein the phosphorus (P) and the sulfur (S) satisfy the following formula (1-2) in terms of element ratio, the boron (B) and the sulfur (S) satisfy the following formula (2-2) in terms of element ratio, and the phosphorus (P) and the boron (B) satisfy the following formula (3-1) in terms of element ratio.
0.50≤[P/(P+S)]≤0.75 (1-2)
0.50≤[S/(S+B)]≤0.75 (2-2)
0.25≤[B/(B+P)]≤0.75 (3-1)

6. The solid electrolyte according to claim 1,
wherein the phosphorus (P), the sulfur (S), and the boron (B) satisfy the following formulas (4), (5), and (6) in terms of element ratio.
0.20≤[P/(P+S+B)]≤0.60 (4)
0.20≤[S/(P+S+B)]≤0.60 (5)
0.20≤[B/(P+S+B]≤0.60 (6)

7. The solid electrolyte according to claim 1,
wherein the phosphorus (P), the sulfur (S), and the boron (B) satisfy the following formulas (4-1), (5-1), and (6-1) in terms of element ratio.
0.20≤[P/(P+S+B)]≤0.30 (4-1)
0.40≤[S/(P+S+B)]≤0.60 (5-1)
0.20≤[B/(P+S+B]≤0.30 (6-1)

8. The solid electrolyte according to claim 1,
wherein the solid electrolyte has peaks at 2θ=25.5° to 25.8° and 26.0° to 26.3° in X-ray diffraction using a CuKα ray.

9. A battery comprising:
a positive electrode active material layer;
a negative electrode active material layer; and
a solid electrolyte which is an oxide-based solid electrolyte, the solid electrolyte being disposed between the positive electrode active material layer and the negative electrode active material layer and containing lithium (Li), phosphorus (P), boron (B), sulfur (S), and oxygen (O) as constituent elements.

10. A manufacturing method for a solid electrolyte, the method comprising:
providing a solid electrolyte, the solid electrolyte being an oxide-based solid electrolyte, and including lithium (Li), phosphorus (P), boron (B), sulfur (S), and oxygen (O) as constituent elements;
forming a negative electrode active material layer on one surface of the solid electrolyte;
forming a positive electrode active material layer on the other surface of the solid electrolyte.
